(19) United States
(12) Patent Application Publication
(10) Pub. No.: US 2012/0315784 A1
(43) Pub. Date: Dec. 13, 2012

(54) Modular Connector System

(76) Inventor: Harald Pankau, Furth (DE)

(21) Appl. No.: 13/518,488

(22) PCT Filed: Dec. 24, 2010
(86) PCT No.: PCT/EP2010/070729

§ 371 Date: Aug. 27, 2012

(30) Foreign Application Priority Data
Dec. 24, 2009 (IB) PCTIB2009056058

(51) Int. Cl. H01R 13/64

(52) U.S. Cl. 439/376

(57) ABSTRACT

The present invention relates to a connector arrangement, including a connector having a connector housing and at least one terminal module, adapted to be inserted into the connector housing. The terminal module is mountable on the connector housing with a freedom of movement in at least one axis, such that the terminal module is capable of self-alignment upon coupling of the connector with a corresponding counter-connector.

### 1. FIELD OF THE INVENTION

The invention relates to modular connector systems for connecting electrical and/or optical components, comprising a housing and at least one module being either a contact module or an optical ferule module.

### 2. TECHNICAL BACKGROUND

In many technical fields opto-electronic devices are more and more common, requiring suitable optical or electrical connection with other cooperating optical, electrical or electronic devices. The increasing complexity of electrical, optical and electronic devices leads to the necessity of increasingly larger connector arrangements to allow a connection of the resulting large number of signal lines. This increase of the number of signal lines to be aligned and/or mated when coupling a connector arrangement may create a number of issues. In the following electrical connector applications are taken as examples, but of course the core of the invention also applies to optical connector applications. Basically the contacts are just replaced bt optical ferules.

For electrical connectors, a large number of electrical contacts increases the force necessary to close the connection between two complementary connector housings. The large coupling forces necessary to close the connectors lead to a number of difficulties. If for example the electrical contacts arranged or hold by the connector housings are not correctly aligned they may be damaged or destroyed if one tries to couple the connectors nevertheless. Since the coupling forces are very high even in the correctly aligned condition of the electrical contacts, an operator may not notice that incorrectly aligned contacts are present and will thus couple the connectors by force, thereby destroying electrical contacts without noticing. This is particular true for connector systems, comprising so called mate assist devices as they were developed in the art to facilitate the coupling of connector systems. Typical examples of such mate assist devices are for example disclosed in EP 0 731 536 A2 and GB 952 652.

Further, in the art so-called modular connector systems were developed, which comprise a connector housing and one or more modules, which are arranged therein. This kind of connector construction facilitates the assembly of the connector, but it does not avoid the above described problems associated with misalignment and/or large mating forces.

Typical examples for such modular connector systems are for example disclosed in U.S. Pat. No. 4,705,332; U.S. Pat. No. 4,655,515 and U.S. Pat. No. 4,846,727. In U.S. '515 and U.S. '727 the housings are provided with a mating face having corresponding passageways or cavities for the insertion of the contacts of a corresponding counter terminal. Thus, the mating face or contact openings of the modules are covered by a mating face of the housing. Upon coupling, the contacts have to be correctly aligned with the mating face of the housing, to avoid any damages thereof.

The known solutions of the prior art function satisfactorily, but still offer room for improvement. All of these solutions have in common, that upon coupling of connector and counter-connector the respective electrical contacts or optical ferules have to be precisely aligned with each other to make a coupling possible. It is therefore an object of the present invention to improve the known connector arrangements and in particular to provide a connector with at least one terminal module which facilitates the coupling process and in particular reduces the risk of an incorrect alignment of the terminals (either electrical contacts or optical ferules) upon coupling. These and other objects, which become apparent upon reading the following description, are solved by a connector arrangement according to claim 1.

### 3. SUMMARY OF THE INVENTION

According to the invention a connector arrangement is provided comprising a connector having a connector housing and at least one terminal module. In this document “terminal” means either electrical contacts or optical ferules. The terminal module houses e.g. a number of terminals therein. It is adapted to be mounted in the connector housing. Most preferably, the terminal module is adapted to be inserted into the connector housing and to be enclosed from the housing to some extent, as e.g. from three sides. The arrangement of the terminal module inside of the connector housing is such that the terminal module has some (pre-defined) freedom of movement in at least one axis, preferably being perpendicular to the coupling or mating direction of the connector. This freedom of movement is provided to a pre-defined extend, such that the terminal module is capable of self-alignment upon coupling of the connector with a corresponding counter-connector. In other words, the terminal module is mounted to the connector housing so as to remain movable with respect to the housing to some extent, in particular in a pre-defined fashion provided by the physical construction of the connector arrangement. With fixed integral connector housings or with modules being fixedly arranged inside of a housing as in the prior art, the mating or coupling process has to be done carefully to avoid damaging or destroying electrical contacts in case of incorrectly alignments. This problem is avoided with the inventive concept of arranging a terminal module with a preferably pre-defined freedom of movement in the connector housing. Preferably, the terminal modules are adapted to be removable from their mounted position inside of the connector housings.

Preferably, the at least one terminal module and the connector housing are provided with corresponding guide means as for example guide ribs and corresponding guide grooves, which interact with each other to guide the insertion of the module into the housing. These guide means are provided with sufficient tolerances so that in assembled condition the module is held in the housing but is still free to move to a sufficient extent to achieve a self-alignment upon coupling of the connector with a corresponding counter-connector. In a most preferred embodiment, the module (or modules) have a freedom of movement in two axis, being essentially perpendicular to each other and both being arranged in a plane perpendicular to the mating or coupling direction of the connector and counter-connector. Most preferably, the freedom of movement allows a pre-defined movement of the module inside of the connector housing in a range comprised between 0.5 mm and 3.0 mm, more preferably between 0.5 and 1.2 mm and most preferably between 0.5 and 1.3 mm. In other words, after the module is correctly mounted or inserted into the connector housing the freedom of movement should be sufficient to allow an adjustment of the position of the module if the same is not correctly aligned upon coupling of the connector with the corresponding counter-connector, but the freedom of movement should at the same time be limited to prevent that the module is moved into a position so far off the correct position that a self-alignment would no longer be possible. Applicant found that the disclosed ranges offer the best compromise in this respect: if the freedom of movement is less than 0.5 mm, a self-alignment is often not possible and if the freedom of movement is larger than 3.0 mm, it can happen that the module is in a position in which it is so far off the correct alignment position that a self-aligning is no longer possible. This is in contrast to the prior art, in which the modules are fixed inside of their respective housings.

In a most preferred embodiment of the invention, the connector housing is provided with at least one opening on one of its side walls which allows access to the module arranged in the housing. Thereby a corresponding alignment member arranged on the housing of the counter-connector can, upon coupling of connector and counter connector, come into contact with the module and guide the same in the correct position necessary for a smooth mating process. Most preferably, the connector is provided in form of a male connector, which is inserted partially in coupled condition into the counter-connector. Thus, the counter-connector comprises an open mating face adapted to receive the connector housing therein and the alignment members can for example be provided in form of protrusions on the inner walls of the (female) counter-connector.

The present invention is in particular suitable for connector arrangements having a large number of electrical contacts that have to be mated with one single mating or coupling action. However, the principle of the present invention, i.e. the self-aligning mechanism offered by a terminal module arranged inside the connector housing with a predefined freedom of movement in at least one axis, can also be used in connection with connector arrangements comprising only a single module with, in extreme cases, a single electrical contact or optical ferule. The self-aligning feature of the terminal module of the present invention is in particular suitable with connector arrangements being provided with a mate assist device, as for example mate assist devices comprising a lever to overcome the mating forces. Due to the lever provided with such arrangements an operator or worker when closing the connection between connector and counter-connector will not easily notice, whether the electrical contacts are correctly aligned between connector and counter connector and will therefore often try to close the connection by force. Thus, in particular with connector arrangements comprising mate assist systems, this often leads to problems with damaged or destroyed electrical contacts. With the self-aligning terminal modules of the present invention these problems can be avoided.

### 4. DESCRIPTION OF THE PREFERRED EMBODIMENTS

In the following, the invention is described exemplarily with reference to the enclosed figures, in which:

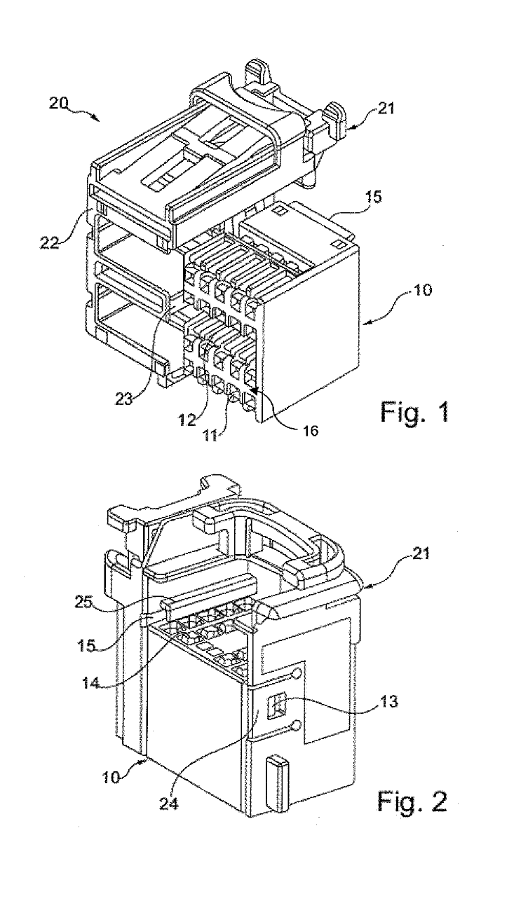

FIG. 1 is a schematic illustration of a connector arrangement in accordance with a first embodiment of the present invention, before assembly;

FIG. 2 shows the same arrangement as FIG. 1 in assembled condition from a different perspective,

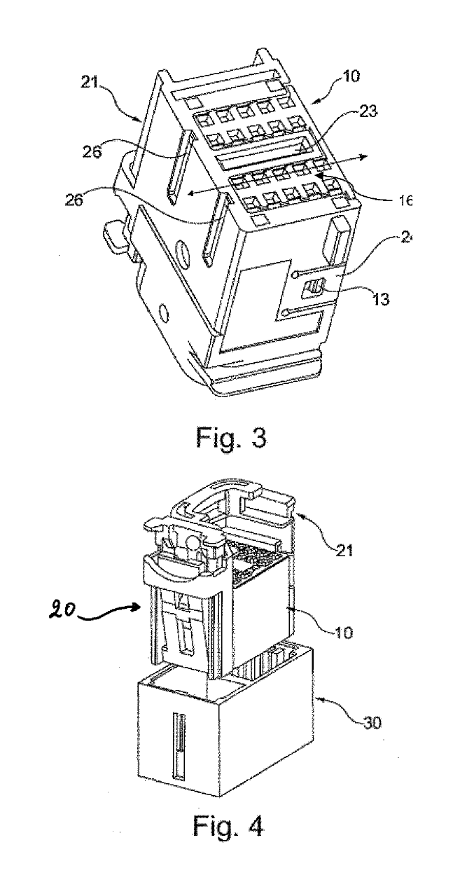

FIG. 3 shows the same arrangement from another perspective;

FIG. 4 shows the connector arrangement of FIGS. 1 to 3 upon coupling with a corresponding counter-connector;

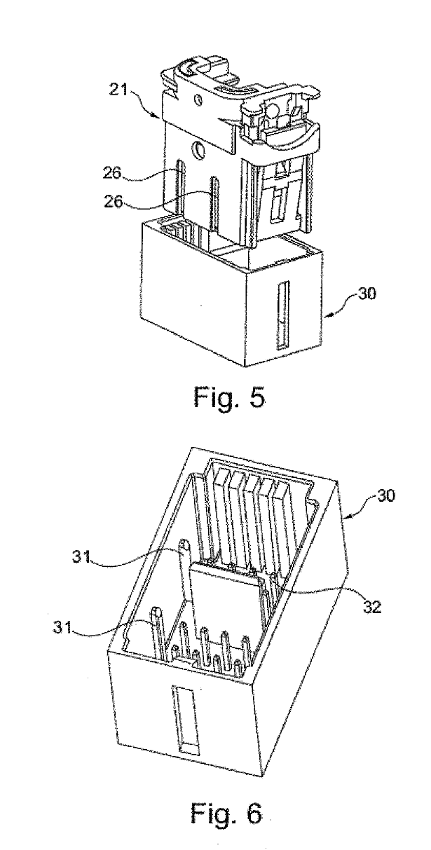

FIG. 5 shows the same arrangement as FIG. 4 from a different perspective;

FIG. 6 shows a schematic illustration of a corresponding counter connector,

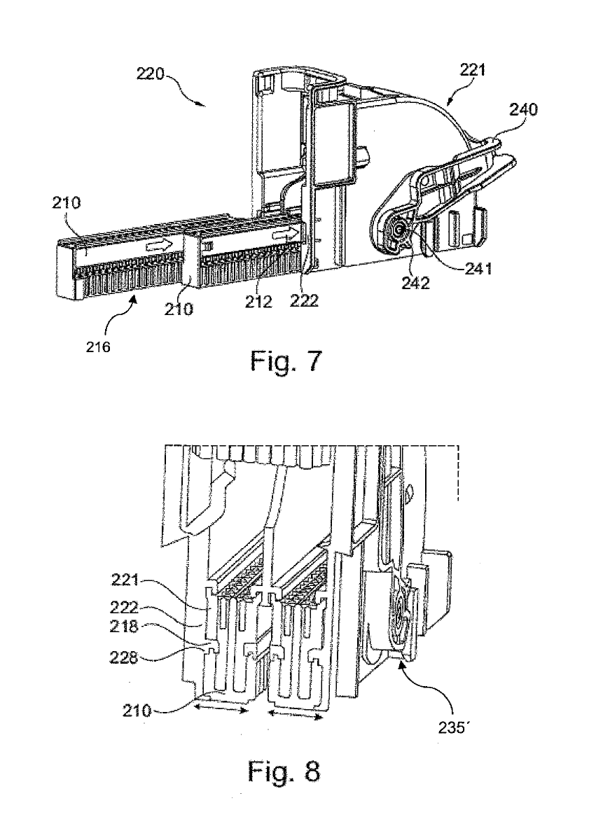

FIG. 7 shows a second embodiment of a connector arrangement in accordance with the present invention;

FIG. 8 shows a detail of the connector arrangement of FIG. 7;

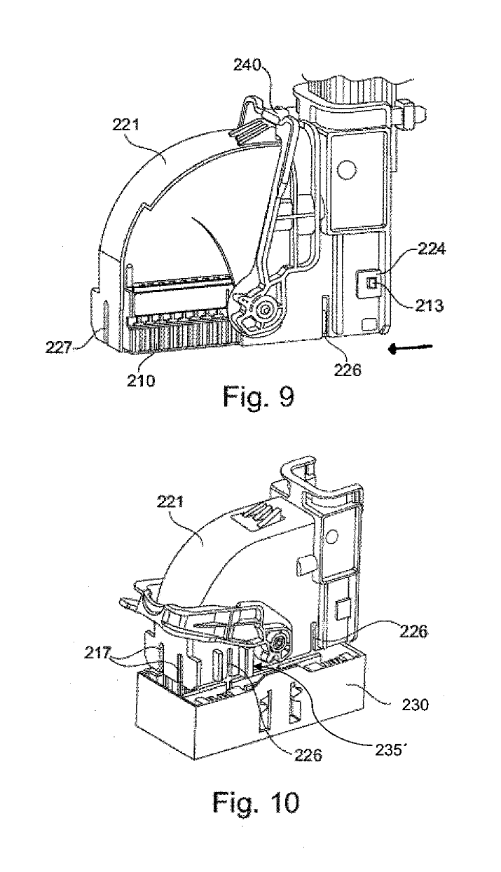

FIG. 9 shows the connector arrangement in assembled condition;

FIG. 10 shows the connector arrangement upon coupling with the corresponding counter connector; and

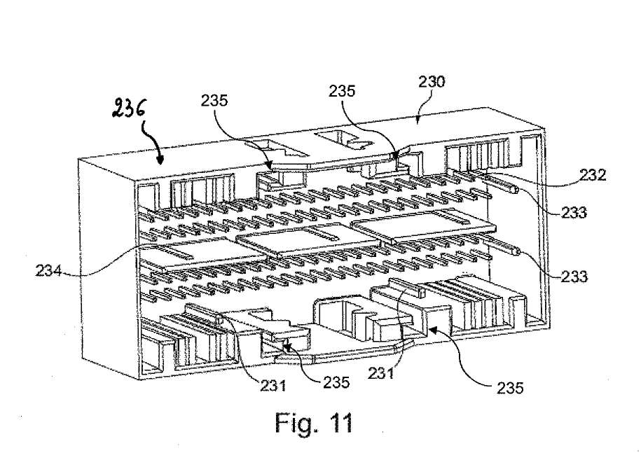

FIG. 11 is a schematic illustration of the corresponding counter-connector of the second embodiment.

In FIG. 1 an arrangement in accordance with a first embodiment of the present invention is shown comprising a connector 20 having a connector housing 21 and a terminal module 10 adapted to be inserted into the connector housing 21. The terminal module 10 is an injection molded plastic part and comprises a mating face 16 having channels 11 each holding a female contact terminal (not shown). The module 10 comprises a guide groove 12 (cf. also to FIG. 3), which is dimensioned to cooperate with corresponding guide means of the connector housing 21. The guide means of the connector housing 21 are provided in form of a guide rib 23. In the perspective of FIG. 1 the mating face 22 of connector housing 21 is arranged towards the reader. As one can see from FIGS. 1 and 3, the housing 21 does not comprises any mating face or wall covering the mating face 16 of the module 10 in assembled condition as it is the case with the above mentioned prior art. Upon assembly, first terminals with respective cables (not shown) are mounted into the channels of the terminal module. The assembled module is afterwards inserted into the housing.

FIG. 2 shows the same connector 20 from a different perspective after the module 10 is inserted into the housing 21. As one can see from FIG. 2, the connector housing 21 surrounds the module 10 from three sides thereof. A further guide rib 15 of the module 10 is inserted into an L-shaped guide channel 25 provided in the interior of the connector housing 21. In the position shown in FIG. 2, the module 10 is secured by means of a flexible latching tongue 24 of the connector housing which interacts with a stop member 13 provided on the module. Thereby, it is prevented that the module 10 be unintentionally lost or removed from its position shown in FIG. 2. However, this securing means does not prevent the module to be movable in its insertion direction to some extent. As one can see from FIGS. 2 and 3, the opening inside of the flexible latching tongue 24 is somewhat larger than the stop member 13 so that the stop member 13 can move for a pre-defined way back and forth in the insertion direction of the module 10, so that also the whole module 10 can be moved accordingly.

In FIG. 3, the mating face of the connector housing 21 is again directed towards the reader. From the perspective of FIG. 3 one can see two openings, namely slots 26 provided in one side wall of the connector housing. These slots 26 extend through the whole thickness of the wall such so that it is possible to mechanically contact or engage the module 10 arranged inside of the connector housing therethrough. As the skilled person will recognise, the slots 26 in connection with the guide means in form of guide rib 23, further guide rib 15, guide groove 12 and guide channel 25 will give the terminal module 10 in its mounted condition a pre-defined freedom of movement in the axis of the insertion direction of the module 10 into the housing 21 as it is indicated by the arrow in FIG. 3. In the embodiment shown, no further freedom of movement is given, since module 10 is tightly guided in all the other directions by the guide means of the arrangement.

As one can further see from FIG. 3, it is possible to remove the module 10 again from the connector housing 21 by lifting the flexible latching tongue 24, so that it comes out of engagement with the stop member 13.

FIG. 4 shows the connector 20 with the module 10 in assembled condition shortly before being inserted into a corresponding counter-connector 30. As the skilled person will recognise, the counter-connector 30 is a female connector adapted to receive the housing 21 at least partially in coupled or mated condition.

In FIG. 5 the arrangement of FIG. 4 is shown from a different perspective, so as to show the slots 26 on the rear side of connector housing 21. As it was mentioned above, the slots allow a mechanical contact with the terminal module 10 arranged in the housing.

From FIG. 6, one can see that the counter-connector 30 is provided on one of its inside walls with two aligning members 31 in form of protruding ribs. As the skilled person will recognise, the aligning members 31 are dimensioned and arranged in the interior of counter-connector 30, so that they will extend into slots 26 and thereby engage through the slots a part of the module 10 arranged in the connector housing 21, thereby guiding the module into a correct alignment with the terminals 32 of the counter-connector.

In FIGS. 7 to 11 a second embodiment in accordance with the present invention is shown. In the following, the parts of the second embodiment will be described using three digit numbers, wherein the first number “2” indicates that it is the second embodiment, and wherein the second and third digits correspond to the like parts of the first embodiment described in connection with FIGS. 1 to 6.

The connector 220 shown on FIG. 7 comprises a housing 221 provided with a mate assist mechanism comprising a lever 240, which is pivotally arranged by means of a pivoting pin 241 on the housing 221. The lever 240 further comprises an actuating tooth 242 for cooperation with a tooth rack (not shown) provided in the corresponding counter-connector. Since the function of such mate assist devices is known to the skilled person it is refrained from a further detailed description thereof. However, for further information it is referred to the documents mentioned above in connection with the discussion of the prior art.

The connector arrangement further comprises two terminal modules 210, which are adapted to be inserted into the connector housing 221 in the direction indicated by the arrows in FIG. 7. The connector housing 221 and the terminal modules 210 are provided with a number of guide means in form of grooves and corresponding guiding ribs. From FIG. 7 one can see a guiding groove 222 provided in the inner wall of the housing 221, which cooperates with protruding guide ribs 212 provided on the modules 210. Similar to the first embodiment, also the connector housing 221 does not comprise any mating face or wall to cover the mating face 216 of the modules 210.

FIG. 8 is a front detail view of the arrangement of FIG. 7. As the skilled person recognises, the modules 210 are further provided with guide grooves 218, which cooperate with corresponding guide ribs 228 provided in the inner wall of the housing 221. The various guide grooves and ribs are dimensioned so that a certain tolerance exists, which allows a pre-defined freedom of movement for the terminal modules, in an axis perpendicular to the insertion direction and parallel to the mating face of the connector housing 221. The freedom of movement is indicated in FIG. 8 by two arrows. It should be noted that the illustrations are only schematic to facilitate the description of the inventive principle and that in practice the freedom of movement in the direction indicated in FIG. 8 is from between 0.5 mm to 1.3 mm.

Additionally, the embodiment of FIGS. 7 to 11 is provided with improved guiding members to facilitate the mating process of connector 220 and counter connector 230. To this end, the outer wall of the housing 221 is provided with two alignment ridges 235′ (see FIG. 10) which are adapted to interact with corresponding alignment or guiding channels 235 provided on the inner wall of counter connector 230 (see FIG. 11). It should be noted that the connector housing 221 preferably comprises two symmetrically arranged ridges 235′ on both opposite sides of the housing. The ridges have substantially an L-shaped cross-section. Referring to FIG. 11, one can see that the counter connector 230 comprises four corresponding guiding channels 235 provided on the inside of the longitudinal connector walls 236. The guiding channels 235 likewise have an L-shaped cross-section to receive the L-shaped ridges 235′ therein. Due to the L-shape these elements prevent bulging or warpage of the walls of the counter connector 230 and outwardly bending upon insertion of the connector housing 221, since the interacting L-shapes of ridges 235′ and channels 235 prevent any deformation of the walls. Ordinary (open) guiding channels and alignment ridges, as for example the alignment members 26, 31 of the embodiment shown in FIGS. 5 and 6, do not offer this advantage since they only provide an alignment in one direction but could not prevent an outward bulging of the two longitudinal side walls 236. Therefore, the provision of at least one corresponding pair of L-shaped alignment members on connector and counter connector is generally preferred in all embodiments, in particular embodiments falling under the scope of the pending claims. Obviously, ridges and channels could be provided on any of connector and counter connector, i.e. the ridges 235′ could be provided on the counter connector 230 and the channels 235 on the connector 220.

Further, the skilled person will recognise that the counter connector 230 is provided with four channels 235 thereby offering the possibility to mount the connector 220 in two orientations, i.e. as shown in FIG. 10, where the lever points to the left side in the drawing or rotated by 180° so that the lever points to the right side in the drawing.

The second embodiment allows a further freedom of movement in another axis perpendicular to the insertion direction of modules 210 into the connector housing 221 and perpendicular to the axis shown in FIG. 8. In this respect FIG. 9 shows the connector arrangement with a part of the wall of connector housing 221 cut open to allow a visualisation of terminal module 210 arranged therein. Similar to the first embodiment also with the second embodiment, the module 210 is secured inside of connector housing 221 by means of a flexible latching tongue 224 provided on the connector housing 221 and a corresponding stop member 213 provided on the module 210. As one can see from FIG. 9, the opening inside of the flexible latching tongue 224 is somewhat larger than the stop member 213 so that the stop member 213 can move for a pre-defined distance in the insertion direction of the module 210 indicated by the arrow in FIG. 9. This arrangement provides a pre-defined freedom of movement. The connector housing 221 is provided with a number of slots 226 on the wall facing the viewer in FIG. 9 as well as with further slots 227 on the wall adjacent thereto. As was explained in connection with the first embodiment, these slots allow physical access to the module 210 arranged inside of the connector housing. Thereby, it is possible that aligning members arranged on the housing of the counter-connector engage the module arranged in the housing upon coupling of connector and counter-connector, so that the terminal module, respectively modules, will self-align upon coupling.

In FIG. 10, the corresponding counter-connector 230 is shown before the connector housing 221 is inserted therein. As the skilled person will recognise, the connector housing 221 is a male connector and the counter-connector 230 is a female connector adapted to receive the connector housing 221 at least partially therein. The connector housing 221 is provided with two slots 226 on each lateral side and two further slots 227 on the shorter side. Thereby, the terminal modules 210 arranged inside of the connector housing 221 can each be engaged on two sides and moved in both axes into a correctly aligned position with regard to the contacts of the counter-connector.

FIG. 11 shows the counter-connector 230 in a schematic top view. One can see that a number of contact pins 232 are arranged inside of counter-connector 230 which have to be correctly aligned with the corresponding modules 210. The precision which is needed for aligning and/or mating the respective terminals of the connector and the counterconnector is given only defined by the respective position of the terminals 232 and aligning members 231, 233, 234 in the counterconnector. The tolerances have mainly to be controlled on the counterconnector, since the modules will be aligned mainly thanks to counterconnector elements. On the right hand side in FIG. 11, one can see two further aligning members 233 in form of protruding ribs, which are dimensioned and arranged to cooperate with the slots 227 arranged in connector housing 221. Correspondingly on the lateral side of counter-connector 230 two further aligning members 231 in form of protruding ribs are arranged, which are arranged and dimensioned to cooperate with slots 226, so that they can align the modules 210 upon mating of connector 220 and counter connector 230. In the middle of counter-connector 230 additionally three guide walls 234 for the same purpose, i.e. to further align the modules 210 in correct position with the contact pins 232. It is important to note that the alignment members are arranged near the mating end of the counter-connector, i.e. their tips will engage and guide the module 210 before the module will come into contact with the pins 232.

All of the shown embodiments are preferably made from injection moulded plastic parts.

1. Connector arrangement, comprising:
a connector having a connector housing; and at least one terminal module, adapted to be mounted to, preferably inserted into, the connector housing; characterized in that the terminal module is mountable to the connector housing with a freedom of movement in at least one axis, such that the terminal module is capable of self-alignment upon coupling of the connector with a corresponding counter-connector.

2. The connector arrangement according to claim 1, wherein the connector housing and the module are provided with guide means to guide the insertion of the module into the housing, which guide means are provided with pre-defined tolerances, chosen so that in assembled condition the module is held in the housing but is free to move to a sufficient extend for the self-alignment.

3. The connector arrangement according to claim 2, wherein the guide means are provided in form of at least one guide rib and at least one corresponding guide groove arranged on respective faces of connector housing and module, which guide rib and guide groove are dimensioned so that in engaged condition of rib and groove a play remains to allow for the self-aligning.

4. The connector arrangement according to claim 1, wherein the module has a freedom of movement in two axes, being essentially perpendicular to each other.

5. The connector arrangement according to claim 1, wherein the freedom of movement allows a movement of the module inside the connector housing in a range comprised between 0.5 mm and 3.0 mm; preferably between 0.5 mm and 2.0 mm and most preferably between 0.5 mm and 1.3 mm.

6. The connector arrangement according to claim 1, wherein one of the connector housing or the module is provided with a stop member which latches behind a corresponding stop shoulder provided on the respective other of housing and module, to prevent an unintended withdrawal of the module from the connector housing.

7. The connector arrangement according to claim 1, wherein the housing is provided with at least one opening, preferably a slot, on one of its side walls, which is adapted to allow an aligning member arranged on the housing of a counter-connector to engage the module arranged in the housing.

8. The connector arrangement according to claim 1, wherein the connector arrangement further comprises a counter-connector being provided with at least one aligning member which guides upon coupling of connector and counter-connector the module into alignment with the contacts of the counter connector.

9. The connector arrangement according to claim 8, wherein the aligning member is arranged near the mating end of the counter-connector so as to engage and guide the module before the terminals of the counter-connector come into contact with the module.

10. The connector arrangement according to claim 1, wherein the connector housing encloses the module in assembled condition and is provided on at least one side with at least one slot being oriented with its longitudinal axis in the coupling direction of the connector housing, and the connector arrangement further comprises a counter-connector being provided on one of its sides with at least one aligning member in the form of an aligning protrusion, which in coupled condition of connector and counter-connector is arranged at least partially in said slot and engages through said slot a part of the module arranged in the connector housing thereby guiding the module into correct alignment with the contacts of the counter connector.

11. The connector arrangement according to claim 8, wherein the connector is provided in form of a male connector and the counter-connector is provided in form of a female connector, so that in coupled condition the connector is at least partially enclosed by the counter-connector.

12. The connector arrangement according to claim 1, wherein the connector housing is provided with a mate assist device comprising a lever.

13. The connector arrangement according to claim 1, wherein the connector and the counter connector are provided with corresponding guide members having essentially an reshaped cross-section adapted to interact with each other to facilitate the alignment of connector and counter connector upon mating thereof.

14. The connector arrangement according to claim 1, wherein in assembled condition, the mating face of the module is not covered by a mating wall of the connector housing.
